(19) United States
(12) Patent Application Publication
(10) Pub. No.: US 2015/0090139 A1
(43) Pub. Date: Apr. 2, 2015

(54) COLLINEAR PRINTING METHOD WITH ROLLER-TYPE UPFRONT GOLD-STAMPING, MATTING AND SNOWFLAKE PRINTED PATTERNS, AND PRINTED PRODUCT THEREOF

(71) Applicant: YAN-SHU LIN, Taichung (TW)

(72) Inventor: YAN-SHU LIN, Taichung (TW)

(21) Appl. No.: 14/042,678

(22) Filed: Sep. 30, 2013

(51) Int. Cl. B44C 1/24

(52) U.S. Cl. CPC B44C 1/24
USPC 101/183

(57) ABSTRACT

Disclosed is a collinear printing method with roller-type upfront gold-stamping, matting and snowflake printed patterns and a printed product manufactured by the method. In a roller-type seven-color automatic printing machine, an adhesive glue is filled into a first printing ink set, and a second printing ink set is modified to be a cold stamping device and mounted with a drum-shaped foil, and the middle section of each printing ink set is filled with printing inks of different desired colors, and the last printing ink set is filled with a repulsive paint and a gold paint. In a printing manufacturing process, a printed matter is processed by a partial cold stamping operation, each of the expected color printing operations is completed in a same-line procedure, the last printing ink set coats the repulsive paint and the gold paint onto the printed matter, and a ground or snowflake pattern is printed onto the printed matter in the same-line according to the mesh size of a mesh ink roller of the gold paint.

### BACKGROUND OF THE INVENTION

1. Fields of the Invention

The present invention relates to a collinear printing method with roller-type upfront gold-stamping, matting and snowflake printed patterns, and a printed product thereof, and more particularly to the method applied to an advanced roller-type printing machine and a novel printing process in a same-line operation to complete the required special stamping and printing effects, so as to improve the printing efficiency and save the total printing cost.

2. Description of the Related Art

In the printing industry, the so-called “gold-stamping” technology refers to the technology of processing a “printed matter” by a color printing process, and then attaching a metal foil material onto a part of the printed matter. Since the foil material is generally a gold, silver or red color material with brilliant brightness, and the transfer process is completed by a hot press mounting technology, so that such technology is generally called “Gilt”, and the printed matters of this sort are commonly used in wedding cards, greeting cards, exquisite business cards, and hardcover publications.

In a traditional manufacturing process, the “gold-stamping” process is an off-line operation. In other words, after the printed matter is processed by the color printing process in a printing machine, a semi-finished good is sent to a designated “blancher” for a secondary manufacture, and then a finished good of the printed matter is manufactured. Obviously, such off-line manufacturing process is time-consuming, thus incurring a higher printing cost and resulting in a higher price of the printed product.

In addition, the so-called ground snowflake printed pattern refers to a special printed pattern formed by printing a repulsive paint and a gold paint which are mixed with each other in a certain ratio on a part or the whole of an end surface of a printed matter, and a layer of rough particles and a special protruding printed pattern are added to increase the feature of the printing layout and the texture of the printed product, and the different effect between the ground and snowflake patterns resides on that the gold paint comes with different particle sizes to provide different visual images. In other words, the particles of a frosted ink are large and rough, but the particles of the snowflake ink are small and fine.

At present, the method of printing the products of this sort generally adopts a four-color automatic printing machine to print desired colors and patterns onto a printed matter and then send the printed matter to another printing machine in an offline operation to coat a special frosted ink or snowflake ink, so as to complete the whole printing process.

The conventional printing process seems to be reasonable, feasible, common, and capable of achieving the required printing effect, but the complicated operation process including loading, unloading and moving the printed matter in the offline operation decreases the printing speed and efficiency significantly and fails to meet the cost-effective and efficient requirements. Obviously, the conventional process requires further improvements.

### SUMMARY OF THE INVENTION

Therefore, it is a primary object of the present invention to use a single printing process to print expected gilt, colored and frost-like or snowflake printed patterns, so as to achieve the effects of improving the printing efficiency and saving the printing time and cost.

According to the invention, a roller-type seven-color automatic printing machine is used, an adhesive glue is filled into a first printing ink set, and a second printing ink set is modified to be a cold stamping device. A drum-shaped foil material is installed, and each printing ink set at the middle section is filled with each color printing ink according to printing requirements. The last printing ink set is filled with a repulsive paint and a gold paint, and printing and delivery process are carried out. The first printing ink set coats an appropriate amount of the adhesive glue partially onto a printed matter according to a soft printing board pattern, and then a corresponding stamping press board of the second printing ink set attaches the foil material with the corresponding pattern onto the printed matter by a laminating adhesion method to complete an upfront partial cold stamping operation. Each printing ink set disposed at the middle section completes each color printing operation in a same-line procedure, and the last printing ink set coats a repulsive paint and gold paint onto the printed matter to complete the same-line printing operation of printing the round or snowflake-like printed pattern onto the printed matter according to the mesh size of a mesh ink roller of the gold paint.

### BRIEF DESCRIPTION OF THE DRAWINGS

The accomplishment of this and other objects of the invention will become apparent from the following description and its accompanying drawings of which:

FIG. 1 is a schematic view of the basic configuration of a roller-type seven-color automatic printing machine and its manufacturing flow chart in accordance with the present invention.

### DETAILED DESCRIPTION OF THE PREFERRED EMBODIMENT

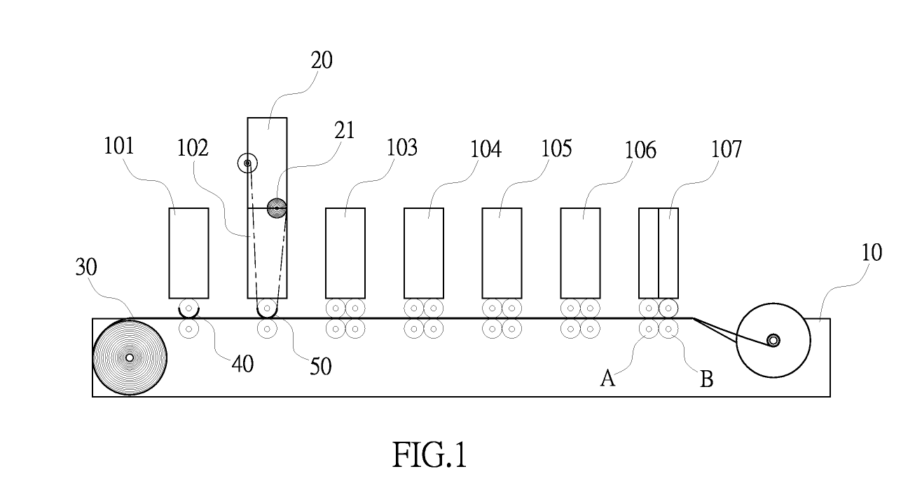

With reference to FIG. 1 for a schematic view of the basic configuration of a roller-type seven-color automatic printing machine 10 of the present invention, an adhesive glue is filled into a first printing ink set 101 of the roller-type seven-color automatic printing machine 10, and a second printing ink set 102 is modified to be a cold stamping device 20, and a drum-shaped foil 21 is mounted, and printing ink sets 103, 104, 105, 106 at the middle sections are filled with different color printing inks respectively according to the printing requirements, and a repulsive paint and a gold paint are filled into the last printing ink set 107. In a printing process, the first printing ink set 101 is provided for partially coating an appropriate amount of adhesive glues onto a printed matter 30 by a printed flexible board 40, and then a stamping press board 50 installed on the second printing ink set 102 is provided for attaching a foil material 21 with a corresponding pattern partially onto the printed matter 30 (which refers to the portion coated with the adhesive glue) by press adhesion method, so as to complete the required partial cold stamping operation, and then four printing ink sets 103, 104, 105, 106 at the middle section are provided for completing each expected color printing operation in the same-line procedure, and then the last printing ink set 107 is provided for coating the repulsive paint and the gold paint onto the printed matter 30, so as to complete the same-line operation of printing a ground or snowflake-like printed pattern onto the printed matter 30 according to the mesh size (not shown in the figure) of a mesh ink roller B attached with the gold paint. The invention can improve the printing efficiency and production capacity in order to save the total printing cost significantly.

The larger the mesh size of the mesh ink roller B, the more ink of the gold plant stuck on mesh ink roller B, and the larger the ink particle of the gold paint, and thus achieving the printing effect of the ground pattern, or else achieving the effect of the snowflake-like pattern.

The present invention uses the roller-type seven-color automatic printing machine 10 and the appropriate additional installation, modification and production of the soft printing board 40 and the stamping press board 50 to fully utilize the existing equipments to improve the production capacity and reduce the manufacturing time and cost, so as to maximize the printing performance of the roller-type seven-color automatic printing machine 10.

Since the roller-type seven-color automatic printing machine 10, cold stamping device 20, foil material 21, and the soft printing board 40 and stamping press board 50 used for coating are basic printing equipments, and thus they will not be described here.

The method of producing the printed product in according to the present invention is described below:

The water-absorbing printed matter 30 refers to a paper material that can be printed with colors. A partially stamped portion is adhered onto the printed matter 30 by the foil material 21 and the stamping press board 50, wherein the partially stamped portion is comprised of different colors and different patterns or lines.

A general colored layer having different colors is printed onto the printed matter 30 to produce the desired pattern.

A repulsive paint layer is coated onto the general colored layer.

A gold paint layer is coated onto the repulsive paint layer to form a ground or snowflake-like printed pattern.

The roller-type seven-color automatic printing machine 10 is a conventional printing machine and refers to a single printing machine with a group of seven printing ink sets, and each ink set can contain an ink of a specific color (such as any one of the primary colors) or a specific paint (such as a gold paint or a repulsive paint), and a mesh ink roller and a soft printing board are provided for printing a pattern with the color ink or the specific oil in the pattern printing process. However, the operation mode and procedure are prior arts, and thus will not be described in details.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A collinear printing method with roller-type upfront gold-stamping, matting and snowflake printed patterns and a printed product thereof, characterized in that a roller-type seven-color automatic printing machine is used, and an adhesive glue is filled into a first printing ink set, and a second printing ink set is modified to be a cold stamping device, and a drum-shaped foil material is installed, and each printing ink set at the middle section is filled with each color printing ink according to printing requirements, and the last printing ink set is filled with a repulsive paint and a gold paint, and printing and delivery process are carried out, wherein the first printing ink set coats an appropriate amount of the adhesive glue partially onto a printed matter according to a soft printing board pattern, and then a corresponding stamping press board of the second printing ink set attaches the foil material with the corresponding pattern onto the printed matter by a laminating adhesion method to complete an upfront partial cold stamping operation, and each printing ink set disposed at the middle section completes each color printing operation in a same-line procedure, and the last printing ink set coats a repulsive paint and gold paint onto the printed matter to complete the same-line printing operation of printing the round or snowflake-like printed pattern onto the printed matter according to the mesh size of a mesh ink roller of the gold paint.

2. A collinear printing method with roller-type upfront gold-stamping, matting and snowflake printed patterns and a printed product thereof, characterized in that a roller-type seven-color automatic printing machine is used, and a first printing ink set coats a layer with an appropriate amount of adhesive glue partially onto a printed matter according to a printed flexible pattern, and then a corresponding stamping press board of a second printing ink set coats a foil material with a corresponding pattern partially onto the printed matter by a laminating adhesion method, so as to complete an upfront partial cold stamping operation, and then each printing ink set at the middle section completes each color printing operation in a same-line flow, and the last printing ink set coats a repulsive paint and a gold paint onto the printed matter, and completes a same-line printing operation of printing a ground or snowflake-like printed pattern onto the printed matter according to the mesh size of a mesh ink roller of the gold paint, and the printed product thereof comprises:
a water-absorbing printed matter, referring to a paper material that can be printed with different colors
a partially stamped portion, adhered onto the printed matter by using the foil material and the stamping press board, and the partially stamped portion being comprised of different colors and different patterns or lines;
a general colored layer, printed onto the printed matter to produce desired pattern and color;
a repulsive paint layer, coated onto the general colored layer; and
a gold paint layer, coated onto the repulsive paint layer to form a ground or snowflake-like printed pattern.

3. The collinear printing method with roller-type upfront gold-stamping, matting and snowflake printed patterns and the printed product thereof according to claim 2, wherein the effect of a ground or snowflake-like printed pattern is achieved by the size of the particle size of the ink of the gold paint layer.
